(19) United States
(12) Patent Application Publication
(10) Pub. No.: US 2007/0058714 A1
(43) Pub. Date: Mar. 15, 2007

(54) IMAGE ENCODING APPARATUS AND IMAGE ENCODING METHOD

(75) Inventor: Reiko NODA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/465,995

(22) Filed: Aug. 21, 2006

(30) Foreign Application Priority Data
Sep. 9, 2005 (JP) 2005-262841

(51) Int. Cl. H04N 11/04; H04N 7/12

(52) U.S. Cl. 375/240.03; 375/240.26

(57) ABSTRACT

An image encoder includes: an image encoder that performs encoding of an image; and a setting unit that sets a quantization parameter for each of encoding units arbitrary defined in the image, the quantization parameter including a rounding offset that is used in the encoding performed by the image encoder. The setting unit changes the rounding offset initially set into a larger rounding offset when brightness information of the encoding unit subjected to the encoding becomes smaller than or equal to a threshold value.

### RELATED APPLICATION

The present disclosure relates to the subject matter contained in Japanese Patent Application No. 2005-262841 filed on Sep. 9, 2005, which is incorporated herein by reference in its entirety.

### BACKGROUND

1. Field of the Invention

The present invention relates to an image encoding apparatus and method for a motion picture or a still picture.

2. Description of the Related Art

Moving picture encoding standard systems, such as ITU-T H.264, ISO/IEC MPEG-2, are irreversible compression systems which subject an input image signal to orthogonal transformation, such as discrete cosine transform (DCT) or the like, to thus convert the image signal along a frequency axis and, then, subject the thus-converted signal to compression processing, including quantization and encoding, to thus generate an encoded image. Accordingly, quantization causes distortion to arise in the encoded image, which deteriorates image quality. Particularly, there is a problem of deterioration of image quality becoming noticeable in a low-brightness area on a screen because of a display characteristic of the display device or the visual characteristics of the human eye which make a person more sensitive to a brightness difference as brightness decreases.

A Japanese Patent No. 3614844 describes a method for eliminating a gamma characteristic from a brightness signal pertaining to an input image; further correcting the input image by use of visual characteristics to thus generate an output signal; and controlling the quantization step (hereinafter called a “quantization step”) on the basis of the output signal. By means of this method, the amount of bits in an area having an extremely is low brightness level or an area having an extremely high brightness level, where deterioration of image quality does not become noticeable, is curtailed, to thus improve image quality of an area having an intermediate brightness level.

The technique described in the Japanese Patent No. 3614844 can prevent deterioration of a dark area to a certain extent. However, prevention is not sufficient, and distortion—particularly in the dark area—becomes noticeable to the human eye.

### SUMMARY OF THE INVENTION

According to a first aspect of the invention, there is provided an image encoder including: an image encoder that performs encoding of an image; and a setting unit that sets a quantization parameter for each of encoding units arbitrary defined in the image, the quantization parameter including a rounding offset that is used in the encoding performed by the image encoder, wherein the setting unit changes the rounding offset initially set into a larger rounding offset when brightness information of the encoding unit subjected to the encoding becomes smaller than or equal to a threshold value.

According to a second aspect of the invention, there is provided an image encoding method including: performing encoding of an image; setting a quantization parameter for each of encoding units arbitrary defined in the image, the quantization parameter including a rounding offset that is used in the encoding; and changing the rounding offset initially set into a larger rounding offset when brightness information of the encoding unit subjected to the encoding becomes smaller than or equal to a threshold value.

According to a third aspect of the invention, there is provided an image encoding method for performing encoding of an image by use of a prediction mode that is selected from among a plurality of prediction modes, for each of encoding units arbitrary defined in the image. The method includes: acquiring an amount of code corresponding to the prediction mode for each of the encoding units; converting brightness information of an input image of the encoding unit and brightness information of a prediction image corresponding to the prediction mode, by use of a value indicating perception characteristics of a human eye with respect to light quantities and use of at least one value indicating a display characteristic of a display device; obtaining encoding distortion by use of the converted brightness information; selecting a pair of an amount of code involving an minimum cost and the encoding distortion from among pairs of the amount of code and the encoding distortion, based on a computing result of a cost by use of an undefined multiplier; and determining the prediction mode to be used for the encoding, based on the selected pair of the amount of code and the encoding distortion.

### BRIEF DESCRIPTION OF THE DRAWINGS

In the accompanying drawings:

FIG. 1 is a block diagram showing the configuration of an image encoder according to a first embodiment;

FIG. 2 is a block diagram showing the configuration of a quantization controller in FIG. 1 according to a second embodiment;

FIG. 3 is a view showing brightness and a visual characteristic of a display device;

FIG. 4 is a flowchart showing processing procedures of a quantization controller;

FIG. 5 is a block diagram showing the configuration of the quantization controller according to the second embodiment;

FIGS. 6A-6D are example ranges of quantization variation computed by a quantization step calculator;

FIG. 7 is a flowchart showing processing procedures of a quantization controller according to a third embodiment;

FIG. 8 is a block diagram showing the configuration of a frame memory/predictive image generator according to a fourth embodiment;

FIG. 9 is a flowchart showing processing procedures of the frame memory/predictive image generator according to the fourth embodiment;

FIGS. 10A-10C are views showing a comparison between a brightness level acquired before encoding and a brightness level acquired after encoding in connection with a related-art display device and the display device of the embodiment; and

FIGS. 11A-11C are views showing a comparison between a quantization step and a rounding offset in connection with the related-art display device and the display device of the embodiment.

### DETAILED DESCRIPTION OF THE PREFERRED EMBODIMENTS

Referring now to the accompanying drawings, a description will be given in detail of embodiments of the invention.

### First Embodiment

An embodiment will be described hereinbelow with reference to the drawings. The present invention is not limited to respective embodiments provided below, and can be utilized in various combinations.

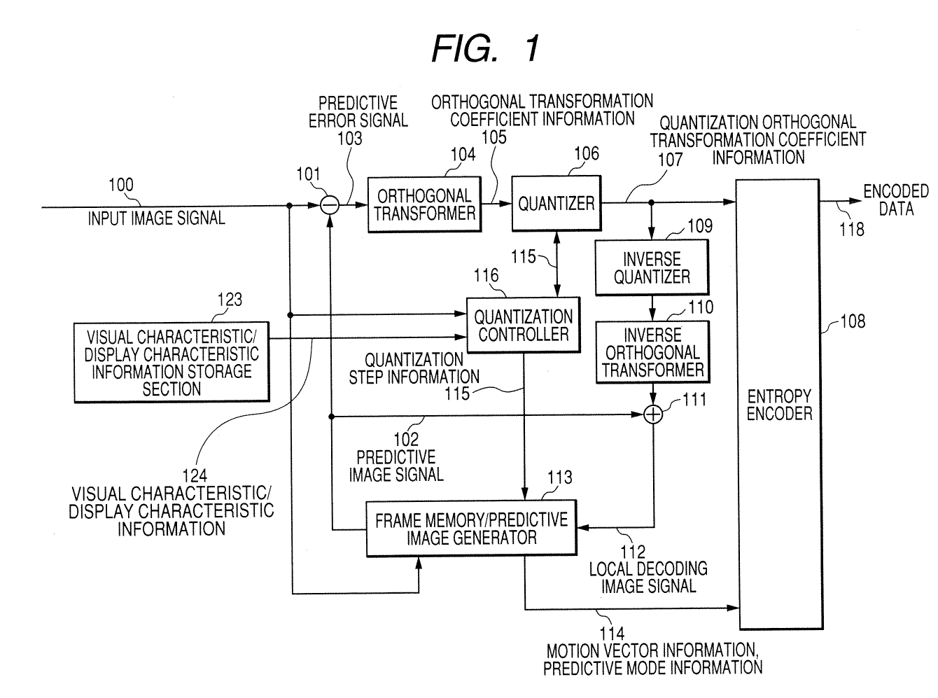

FIG. 1 is a block diagram showing the configuration of an image encoder for encoding a motion picture according to a first embodiment.

As shown in FIG. 1, this image encoder has a subtractor 101, an orthogonal transformer 104, a quantizer 106, an entropy encoder 108, an inverse quantizer 109, an inverse orthogonal transformer 110, an adder 111, a frame memory/predictive image generator 113, a quantization controller 116, and a visual characteristic/display characteristic information storage section 123.

First, a motion picture signal is input on, e.g., a per-frame basis, as an input image signal 100 for the image encoder. The subtractor 101 determines a difference between the input image signal 100 and a predictive image signal 102, to thus generate a predictive error signal 103. The orthogonal transformer 104 subjects the thus-generated predictive error signal 103 to orthogonal transformation; e.g., discrete cosine transformation (DCT). The orthogonal transformer 104 generates orthogonal transformation coefficient information 105; e.g., DCT coefficient information. After having been quantized by the quantizer 106, the orthogonal transformation coefficient information 105 is bifurcated. One of pieces of bifurcated, quantized, orthogonal transformation coefficient information 107 is led to the entropy encoder 108.

Next, the remaining piece of bifurcated, quantized, orthogonal transformation coefficient information 107 is sequentially subjected to processing of the inverse quantizer 109 and processing of the inverse orthogonal transformer 110, which are reverse to that of the quantizer 106 and that of the orthogonal transformer 104, whereby the signal is made analogous to the predictive error signal. This predictive error signal is added to the predictive image signal 102 by means of the adder 111, to thus generate a local decoding image signal 112. The local decoding image signal 112 is input to the frame memory/predictive image generator 113.

Next, the frame memory/predictive image generator 113 generates a predictive image signal based on certain predictive mode information, from the input image signal 100 and the local decoding image signal 112. At this time, the local decoding image signal 112 output from the adder 111 is temporarily stored in the frame memory/predictive image generator 113. The input image signal 100 and the local decoding image signal 112 stored in the frame memory/predictive image generator 113 are matched (e.g., block-matched) for each block in a frame, to thus detect a motion vector. The predictive image signal 102 is generated by use of the local image signal compensated by the motion vector. The thus-generated predictive image signal 102 is output from the frame memory/predictive image generator 113 along with motion vector information/predictive mode information 114 of the selected predictive image signal 102.

Next, the entropy encoder 108 subjects the quantized orthogonal transformation coefficient information 107 and the motion vector information/predictive mode information 114 to entropy encoding. The thus-generated encoded data 118 are delivered to an unillustrated transmission system or storage system.

Next, visual characteristic/display device characteristic information 124, such as a parameter showing the visual characteristic of the human eye in response to light or a parameter showing a characteristic of a display device, is stored in the visual characteristic/display device characteristic information storage section 123, and the visual characteristic/display device characteristic information 124 is input to the quantization controller 116.

The quantization controller 116 receives the quantization step information 115, which is to become a standard, from the quantizer 106, as well as receiving the visual characteristic/display device characteristic information 124. The quantization controller 116 analyzes the input image signal 100; adjusts the quantization step such that the size of encoding distortion on the display device becomes constant within a screen; and inputs the thus-modified quantization step information to the quantizer 106.

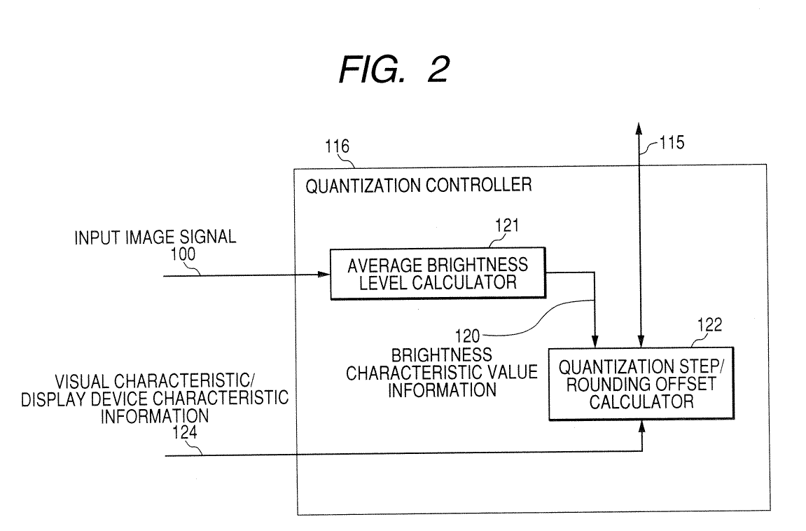

FIG. 2 shows a specific example of the quantization controller 116. This quantization controller 116 has a brightness characteristic value calculator 121 and a quantization step/rounding offset calculator 122.

The a brightness characteristic value calculator 121 divides, for instance, the input image signal 100, which is one frame unit, into macro blocks units; calculates brightness characteristic values 120 of the respective macro blocks; and inputs the thus-calculated brightness characteristic values 120 into the quantization step/rounding offset calculator 122. The visual characteristic/display device characteristic information 124 is input to the quantization step/rounding offset calculator 122.

An example of the visual characteristic/display device characteristic information 124 will be described hereinbelow.

TABLE 1

| | |
|---|---|
| VISUAL CHARACTERISTIC | α = 3.0 |
| PARAMETER | |
| GAMMA VALUE OF | γ = 2.2 |
| DISPLAY DEVICE | |
| REPRODUCIBLE MINIMUM | Yjnd = 24 |
| INPUT BRIGHTNESS | |
| LEVEL OF DISPLAY DEVICE | |
| INPUT BRIGHTNESS LEVEL | Ymin = 16 |
| RELATED TO MINIMUM | |
| LEVEL OF INPUT SIGNAL | |
| OF DISPLAY DEVICE | |
| INPUT BRIGHTNESS LEVEL | Ymax = 235 |
| RELATED TO MAXIMUM | |
| LEVEL OF INPUT SIGNAL | |
| OF DISPLAY DEVICE | |
| . | . |
| . | . |
| . | . |
| . | . |
| . | . |
| . | . |

The visual characteristic parameter α shows a relationship of E=kL^{1/α}, provided that the quantity of light of the display device is L and the amount of sensitivity to brightness perceived by the human eye is E. A denominator α of an exponent section is taken as a visual characteristic parameter.

Since a relationship of L=I^{γ} exists in connection with the quantity of light L output in response to an input voltage I, an index portion γ of the display device is a value representing a characteristic of the display device.

An input brightness level Ymin related to the minimum level of the signal input to the display device is the minimum brightness level that is a standard at the time of conversion of an input brightness level into an input voltage signal.

An input brightness level Ymax related to the maximum level of the signal input to the display device is the maximum brightness level that becomes a standard at the time of conversion of an input brightness level into an input voltage signal.

Accordingly, the voltage I input to the display device at a certain brightness level Y is computed from Ymax and Ymin, as follows.
I=β(Y−Y min)/(Y max−Y min) Expression 1

For example, Ymin=16, Ymax=235, which are determined by specifications of NTSC, are used for Ymax and Ymin. However, in the present invention, Ymax and Ymin are not limited to these values. Preset fixed values may also be employed, or the minimum brightness value and the maximum brightness value of pixels in a frame which is being processed may be stored as Ymin and Ymax in accordance with the dynamic range of the input brightness signal. Alternatively, the minimum brightness value and the maximum brightness value of the entire input image stream may be stored. A brightness histogram of an input image may be computed, and a minimum brightness value including the minimum number of pixels—where S% pixels of the entire number of pixels appear—may be stored. Values other than those mentioned above may be stored.

The reproducible minimum input brightness level Yjnd of the display device is the minimum brightness value where the brightness does not become lower when the image is displayed on the display device. The reproducible minimum input brightness level is generally a value which is closely relevant to settings of brightness or black level of the display device.

In contrast with the case of the example set above, where the parameters used for computing the characteristic of the display device are stored, the brightness output by the display device at respective halftone levels may be stored in the form of a table.

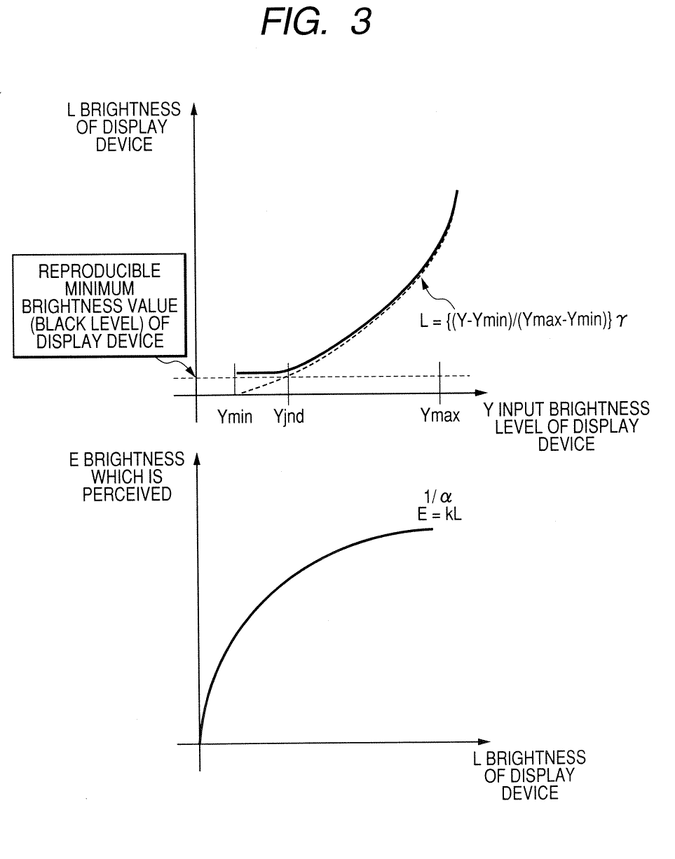

FIG. 3 shows an example of the above-described visual characteristic and that of the display device characteristic.

The graph in FIG. 3 is a chart showing a common relationship between the brightness level Y of the image signal input to the display device and the brightness L output by the display device, showing a nonlinear characteristic of L=Y^{γ}. Ordinary specifications describe γ=2.2. Accordingly, in a case where the minimum brightness level is input by means of an input image signal, when the brightness represented by the display device approaches zero, a characteristic corresponding to a broken line on the graph is obtained. However, the actual display device can represent the area that is displayed the darkest by the characteristic of the display device, at a brightness level of a certain value or more. The lowest brightness level of the darkest area is limited to a certain level by means of settings of the black level (brightness), and a characteristic designated by a solid line in the graph is obtained. Meanwhile, the graph provided in a lower portion of FIG. 3 shows the visual characteristic of the human eye. Provided that the brightness perceived in response to the brightness L of the display device is taken as E, there exists a relationship of E=kL^{1/α} (“k” is a constant) which is reverse to the characteristic of the display device.

The quantization step/rounding offset calculator adjusts quantization step information 115, on the basis of the quantization step information 115 input from the quantizer 106 shown in FIG. 1, the brightness characteristic value 120, and the visual characteristic/display device characteristic information 124, such that the size of encoding distortion on the display device becomes constant within the screen; and outputs the thus-modified quantization step information 115 to the quantizer 106. A computing method will be described later.

In the present embodiment, the encoding unit is, e.g., a macro block unit. However, the present invention is not limited to this unit.

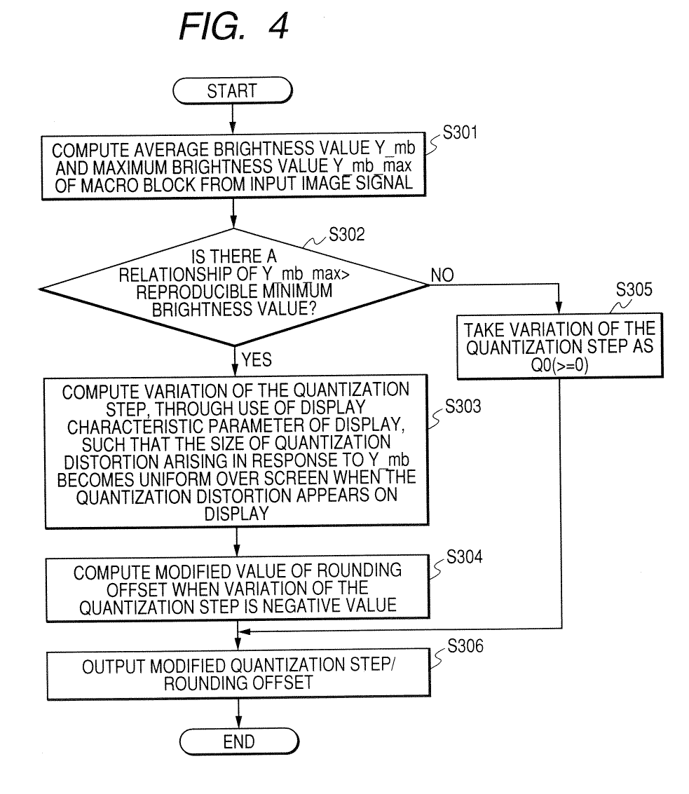

FIG. 4 is a flowchart showing the flow of operation of the quantization controller 116. Specific examples of processing pertaining to steps S301 to S306 are shown.

First, in step S301, a brightness characteristic value of the macro block is computed from the input image signal 100. In the present embodiment, a mean brightness value Y_mb and the maximum brightness value Y_mb_max, which pertain to the pixels in a macro block, are used as the brightness characteristic values used for computing the range of modification of the quantization step. However, the brightness characteristic values are not limited to an average value and the maximum value. For instance, a minimum brightness value and a median brightness value, which pertain to a macro block, may be used. In addition, at the time of computation of these values, pixels in the macro block are sampled, and computation may be performed with a smaller number of pixels.

In step S302, a determination is made as to whether or not the maximum brightness value Y_mb_max, which is the brightness characteristic value of the macro block, is larger than the reproducible minimum brightness value Yjnd of the display device. The reproducible minimum brightness value Y_jnd is previously stored in the visual characteristic/display device characteristic information storage section 123.

In step S303, by reference to the visual characteristic/display device characteristic information 124 about the display device, variations in the quantization step are computed so as to render the size of quantization distortion, which is generated in response to the average brightness value Y_mb and perceived on the display device, uniform within the screen. Specifically, as indicated by Mathematical Expression 2, provided that reference distortion achieved when a certain reference brightness Y_base is encoded within a quantization step input from the quantizer 106 is taken as D_base and that the size of distortion to the brightness Y_mb of the macro block that is being processed is D_mb, the essential requirement is that a difference in brightness perceived on the display device before and after occurrence of the distortions D_base and D_mb must be constant.
(Y_base+D_base−Y min)^{γ/α}−(Y_base·Y min)/^{γ/α=(}Y_{—}mb+D_{—}mb−Y min)^{γ/α}−(Y_{—}mb−Y min)^{γ/α} Expression 2

This expression is solved in connection with D_mb, and the following expression is obtained.

$${D\_mb = {\{ {( Y\_base + D\_base - Y min )}^{γ / α} - Y\_base - Y min )}^{γ / α} + \\ {( Y\_mb - Y min )}^{γ / α} \}}^{α / γ} + Y\_min - Y\_mb \qquad Expression 3$$

For instance, on the assumption that H.264/MPEG-4 AVC is taken as an encoding system to which the present invention is to be applied, a distortion value D acquired when encoding is performed with a quantization step QP assumes a relationship such as that represented by mathematical Expression 4.
D=a×2^{b×QP} Expression 4

When the quantization step input from the quantizer 106 is taken as QP_base and the range of modification to the quantization step to be computed is taken as ΔQP, mathematical Expression 5 is obtained for D_base and D_mb, which are resultantly generated. In the mathematical Expression 5, “a” is a numerical constant.
D_base=D=a×2^{b×QP}^{_{—}}_{base},
D_{—}mb=D=a×2^{b×(Qp}^{_{—}}_{base+ΔQP)} Expression 5

Namely, the modification range ΔQP is expressed as mathematical Expression 6.
ΔQP=log₂(D_{—}mb/D_base) Expression 6

As above, Mathematical Expression 3 is substituted into mathematical Expression 6, so that the variation ΔQP in the quantization step can be computed as expressed by mathematical Expression 7 from the brightness of the processing macro block, the certain reference brightness Y_base, the reference distortion D_base, and the visual characteristic/display characteristic information 124, such that the size of quantization distortion, which arises in relation to the average brightness value Ybase and is perceived on the display device, becomes uniform within the screen.

$$Δ QP = {log}_{2} ( {\{ {\{ Y\_base + D\_base + Y min )}^{γ / α} - \\ {( Y\_base - Y min )}^{γ / α} + {( Y\_mb - Y min )}^{γ / α} \}}^{α / γ} + \\ Y\_min - Y\_mb \} / D\_base ) \qquad Expression 7$$

Y_base is reference brightness; Y_mb is an average brightness value of a macro block; and D_base is a reference distortion value. Y_min is an input brightness level corresponding to the minimum level of the signal input to the display device; γ is a gamma value of the display device; and α is a parameter showing the above-described visual characteristic in relation to brightness and previously stored in the visual characteristic/display device characteristic information storage section 123.

When the average brightness value Y_mb of the macro block is equal to or less than Y_min, ΔQP cannot be computed correctly in terms of the characteristics of the expression. In such a case, ΔQP is computed on, e.g., the assumption of Y_mb=Y_min+1.

For instance, a preset fixed value may be used for the reference brightness Y_base that is used for computing the range of variation, or an average of the brightness values of the pixels in the frame currently being processed may also be employed. Alternatively, a value other than those set forth may be used. Computation of the range of modification is not limited to the expression described above. Another expression may be used, so long as the expression which enables computation of a variation in the quantization step such that the size of quantization distortion perceived on the display device becomes uniform in the screen. For instance, various expressions can be used in consideration of the characteristic of the encoding system to which the present invention is applied.

In step 304, when the variation in the quantization step computed in step 303 assumes a negative value, a modified value of the rounding offset is computed. For instance, the previously-set rounding offset is multiplied by a factor of “k” (1<k). For instance, when the rounding offset is set to one-quarter, the rounding offset is modified to k/4. Here, modification is performed by means of k-fold multiplication. However, computation is not limited to multiplication. Any method, e.g., a method for making modifications by means of addition, may be employed, so long as the method is for effecting modification such that the resultant value becomes greater than the original offset. However, the modified offset is preferably modified so as to become smaller than one.

In step 302, when the maximum brightness value Y_mb_max of the macro block is smaller than the reproducible minimum brightness value Yjnd, the range of modification of the quantization step is set, in step S305, to a value Q0 which is greater than 0. A value, which is previously stored in the visual characteristic/display characteristic parameter storage section 123, is used for the reproducible minimum brightness value Yjnd.

Finally, the computed quantization step and the modified value of the rounding offset are output in step S306.

According to the above quantization step modification method, respective modified values are consecutively computed in relation to the respective macro blocks. If the visual characteristic/display device characteristic information 124 is information which remains unchanged when subjected to a round of encoding operations, the modification range (ΔQP) of the quantization step of the brightness characteristic value and presence/absence of modifications to the rounding offset, or the like, are computed and results of computation are stored in memory. Reference is made to the table in connection with the brightness characteristic value, whereby the modified values can also be determined.

According to the present embodiment, the quantization step is modified such that the encoding error perceived on the display device becomes constant in the screen, in consideration of the visual characteristic in response to brightness and the characteristic of the display device. Therefore, distortion of a dark area which is easily noticed can be reduced, to thus improve subjective image quality. Further, the rounding offset of the dark area is also greatly modified, whereby minute dark noise in the input image is eliminated by quantization, and deterioration of the block is prevented. Thus, superior subjective image quality can be achieved. In addition, the quantization step of a macro block with a brightness value which is too small to be reproduced on the display device is not modified or greatly modified, to thus reduce the amount of bits. The amount of bits of the macro blocks whose brightness values fall within a reproducible range can be relatively increased. Hence, superior subjective image quality can be obtained.

### Second Embodiment

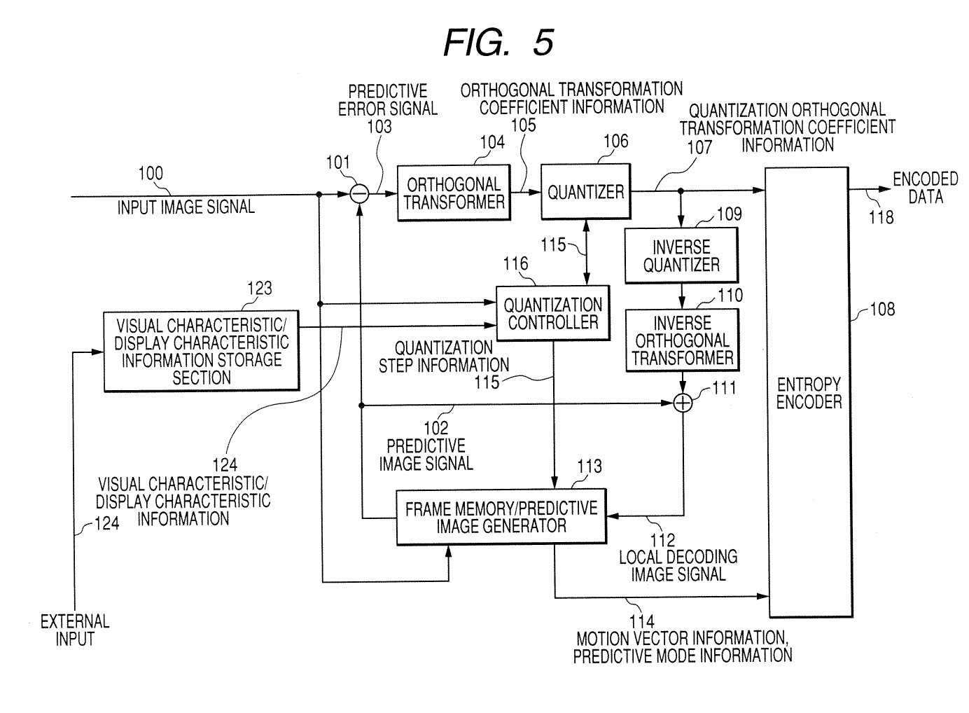

FIG. 5 is a block diagram of the entire image encoder according to a second embodiment. Although the present embodiment is essentially analogous to the first embodiment, the present embodiment differs from the first embodiment in that the visual characteristic parameter and the display characteristic parameter can be input from the outside to the visual characteristic/display characteristic information storage section 123. Operation of the quantization controller 116 is essentially analogous to the operation of the quantization controller 116 of the first embodiment. However, they differ from each other in that the values, which have been input from the outside and stored in the visual characteristic/display characteristic information storage section 123, are used as the visual characteristic/display characteristic information 124 (α, γ, Yjnd, Ymin, Ymax) used in mathematical Expression 7, i.e., a formula pertaining to the range of modification to the quantization step.

Input of these parameters may be performed by means of acquiring predetermined information from, e.g., a server connected to the Internet, or acquiring predetermined information from a connected display device or a display device specified by the user. The input method is not limited to that mentioned herein. An example of variation in the quantization step computed by the quantization controller 116 is described hereinbelow in connection with, e.g., a case where the connected display device is an LCD and a case where the connected display device is a CRT.

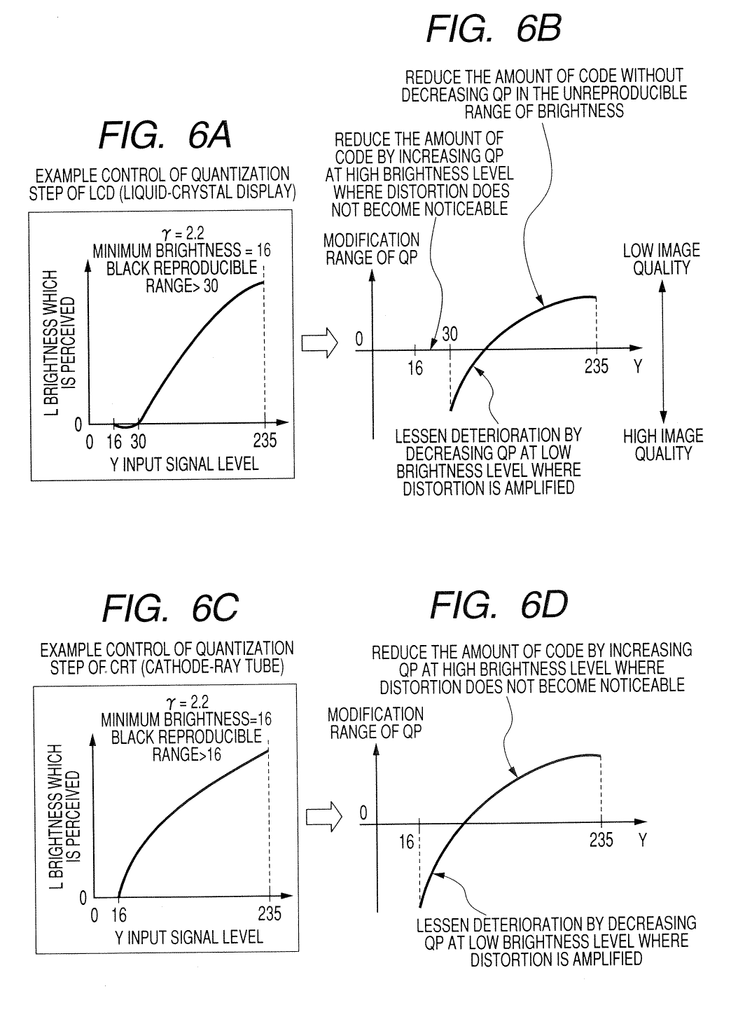

FIG. 6A is a view showing a relationship between the brightness level of an input image and the brightness perceived on the LCD with regard to the case where the connected display device is an LCD (liquid-crystal display).

From the viewpoint of the characteristic of the LCD, brightness responsive to a black level is comparatively bright. When the brightness level of the input image falls within the range of 30 and less, as in the case of the embodiment shown in FIG. 6A, the same brightness (=black level) is displayed on the LCD. Consequently, the visual characteristic/display characteristic information 124 (α, γ, Yjnd, Ymin, Ymax), which is input to the visual characteristic/display characteristic information storage section 123 and which shows the visual characteristic and the display characteristic relative to input brightness, assumes values of, e.g., (3.0, 2.2, 30, 16, 235).

When the range of modifications to the quantization step is computed from the parameters as in the case of the first embodiment, the range of modification, such as that shown in FIG. 6B, is computed. The horizontal axis represents average brightness of a macro block, and the vertical axis represents the range of modifications to the quantization step. The smaller the range of modifications to the quantization step, the better the image quality. However, the amount of bits is also relatively increased. In the LCD of this embodiment, when the brightness level of the input image falls within the range of 30 and less, the brightness on the LCD is perceived as the same brightness. Therefore, even when deterioration of image quality has been caused by encoding, the deterioration cannot be perceived.

Consequently, in the embodiment shown in FIG. 6B, the range of modifications to the quantization step of macro blocks having a halftone level of 30 or less is set to 0, to thereby reduce the quantization step. Thus, an increase in the amount of bits is reduced. In contrast, in the case of an input image having a brightness level of 30 or more, a difference in brightness can be perceived on the display device, and deterioration of a darker area can be more readily perceived because of the visual characteristic in response to brightness. For this reason, the range of modification is computed such that the quantization step becomes smaller in an area where the brightness of an input image is smaller. Thereby, the amount of bits of an area where an input brightness level is too small to be represented on the LCD is reduced, to thus prevent occurrence of deterioration of a dark area.

FIG. 6C is a view showing a relationship between the brightness level of an input image and the brightness perceived on a CRT with regard to the case where the connected display device is a CRT. As shown in FIG. 6C, in contrast with the case of the LCD, brightness on the CRT corresponding to a black level is very low. For instance, brightness levels (16 to 235) of an input image specified by the specifications of NTSC are clearly displayed with a difference in brightness. Consequently, in this embodiment, the visual characteristic/display characteristic information 124 (α, γ, Yjnd, Ymin, Ymax), which is input to the visual characteristic/display characteristic information storage section 123 and which shows the visual characteristic and the display characteristic relative to input brightness, assumes values of, e.g., (3.0, 2.2, 16, 16, 235).

As in the case of the first embodiment, the range of modifications to the quantization step is computed from these parameters, to thus compute the range of modification such as that shown in FIG. 6D. In the CRT of this embodiment, all halftone levels can be represented as different brightness levels in relation to the brightness level of the input image. In consideration of the visual characteristic of deterioration in a darker area being more readily perceived, the range of modifications is computed such that the quantization step becomes smaller in a less-bright area, thereby preventing deterioration of the dark area.

The present embodiment shows that control appropriate to a display device can be performed by utilization of the fact that the reproducible minimum input brightness level Yjnd of a display device changes from one display device to another. However, even in the case of the same display device, an encoded image of subjective quality suitable for settings of a display device can be obtained, by means of inputting, as the visual characteristic/display characteristic information 124, settings of, e.g., a black level (brightness/luminance) and a white level (contrast), presence/absence of black extension processing, a gamma characteristic whose dark halftones are further extended for a moving picture purpose, and a gamma characteristic whose intermediate halftones are extended for a clear video.

The parameters input as the visual characteristic/display characteristic information 124 are not limited to the values mentioned above. Any parameters may be adopted, so long as the parameters pertain to the visual characteristics and the characteristics of a display device and a difference perceived on the display device can be simulated.

According to the present embodiment, noticeable distortion of a dark area is prevented, and subjective image quality is improved. In addition, subjective image quality optimal for each display device can be obtained, by means of inputting parameters, such as characteristics of the display device that displays a demodulated image, the value of a preset black level, and the like.

### Third Embodiment

In the present embodiment, the block diagram of an entire image encoder is analogous to those of the first and second embodiments. However, the present embodiment differs from the first and second embodiments in that selection is performed in accordance with the number of DCT coefficients obtained when the quantization controller 116 has quantized a macro block whose quantization step is to be modified.

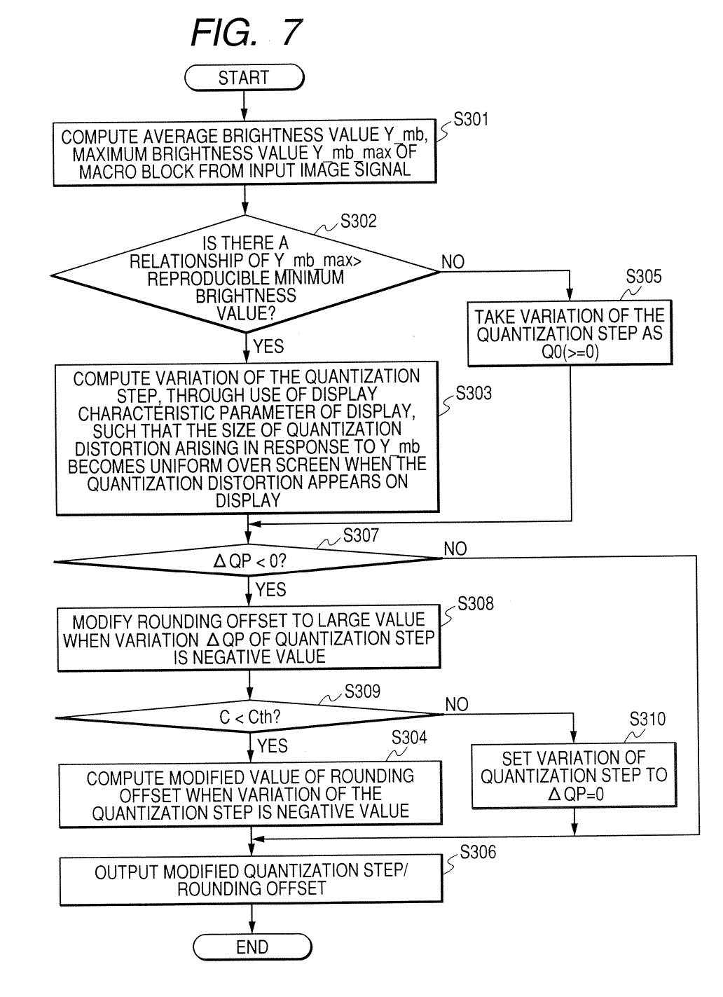

FIG. 7 is a flowchart showing an example operation of the quantization controller 116 of the present embodiment.

Operations pertaining to S301 to S303 and operation pertaining to S305 are the same as their counterparts in the first embodiment, where a value of the range of modifications to the quantization step is determined.

Next, in step S307, a determination is made as to whether or not the range of modification to the quantization step assumes a negative value. When the range of modification assumes a negative value, processing proceeds to step S308. Quantization is performed on the basis of the input pre-correction quantization information 115, and there is counted the number C of DCT coefficients having values other than 0 among quantized DCT coefficients.

Next, in step S309, a determination is made as to whether or not the number C of counted DCT coefficients is less than Cth. When the number of DCT coefficients is determined to be K or more, processing is terminated, and no modifications are made to the quantization step. Meanwhile, when the range of modification to the quantization step is determined to be negative in step S307 and when the number C of DCT coefficients counted in step S309 is determined to be less than Cth, processing proceeds to step S304, where the quantization step and a value of modification to the rounding offset are computed in the same manner as in the first embodiment. Finally, the quantization step computed in step S306 and the modified value of the rounding offset are output.

According to the present embodiment, by means of the characteristic of distortion attributable of encoding distortion becoming less noticeable in a dark area within the macro block having a large number of non-zero DCT coefficients, the amount of bits can be diminished by means of making no modifications to the quantization step of a dark area where a large number of non-zero DCT coefficients are present. Accordingly, the amount of bits can be assigned to a bright area while enhancing the image quality of a dark area where deterioration becomes noticeable. Thus, subjective image quality can be improved further.

### Fourth Embodiment

An image encoder according to a fourth embodiment is essentially the same as the counterparts of the first to third embodiments in terms of overall configuration. The present embodiment differs from the first to third embodiments in that the frame memory/predictive image generator 113 selects a prediction mode in consideration of the visual characteristic to brightness and the characteristic of the display device.

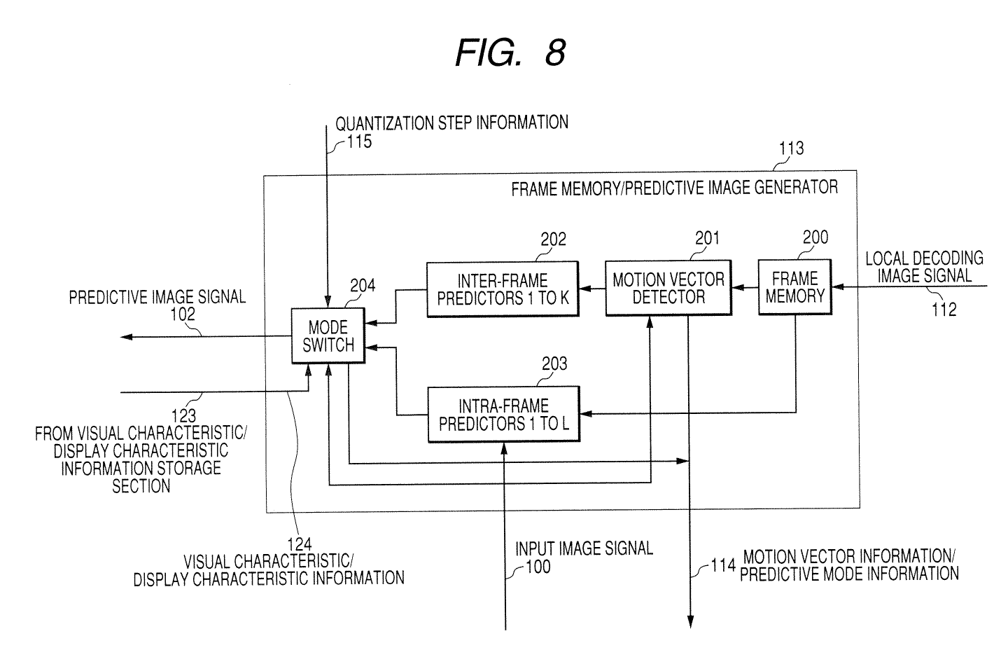

FIG. 8 is a block diagram of the frame memory/predictive image generator 113 of the present embodiment.

The local decoding image signal 112 output from the adder 111 shown in FIG. 1 is temporarily stored in frame memory 200 shown in FIG. 8. A motion vector detector 201 (performs block matching) matches the input image signal 100 to the local decoding image signal stored in the frame memory 200 for each block in a frame, to thus detect a motion vector.

Next, an inter-frame predictor 202 subjects the local decoding image signal in the frame memory 200 to motion compensation on the basis of the motion vector detected by the motion vector detector 201, to thus prepare a predictive image signal based on an inter-frame prediction. An intra-frame predictor 203 prepares a predictive image signal, which is based on the intra-frame prediction, from the input image signal 100 and the local decoding image signal which is in the frame memory 200 and pertains to an encoded area in the frame.

The inter-frame predictor 202 has K (K is plural) inter-frame prediction modes, and the intra-frame predictor 203 has L (L is plural) intra-frame prediction modes. A mode switch 204 is connected to an output of the inter-frame predictor 202 and an output of the intra-frame predictor 203. The mode switch 204 outputs a predictive image signal based on one prediction mode which has been selected from the K inter-frame prediction modes or a predictive image signal based on one prediction mode which has been selected from the L intra-frame prediction modes.

The motion vector information/prediction mode 114; namely, the motion vector information output from the motion vector detector 201 and the prediction mode information showing the prediction mode selected by the mode selector 121 by means of the switch 204, is delivered to the entropy encoder 108. The motion vector information is output from the motion vector detector 201 only when the inter-frame prediction mode is selected.

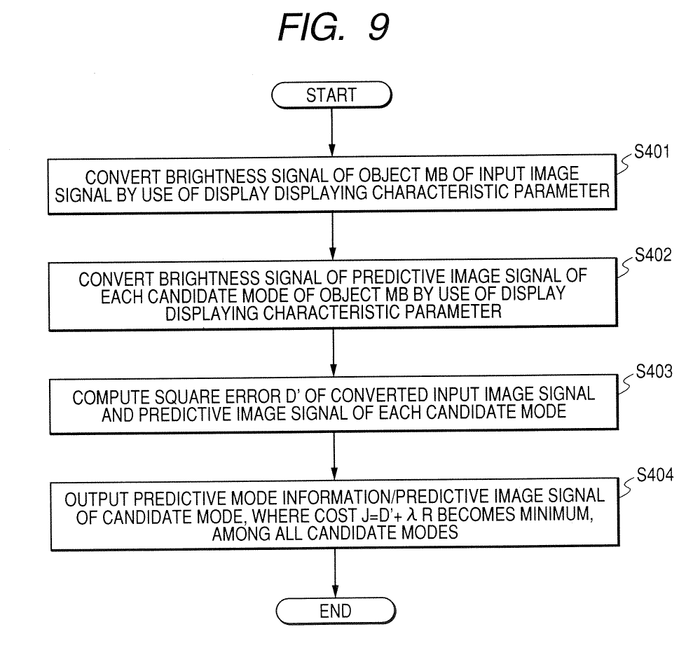

FIG. 9 is a flowchart showing operation of the mode switch 204.

First, in step S401, brightness of respective pixels in the input image signal pertaining to the macro block that is being processed is converted by use of the visual characteristic/display characteristic information 124. Conversion is performed by use of, e.g., mathematical Expression 8.
Y′=255×{min((Yjnd−Y min), (Y−Y min))/(Y max−Y min)}^{γ/α} Expression 8

In Expression 8, Y is a pre-conversion brightness value of a pixel; Y′ is a post-conversion brightness value of a pixel; Ymin is the minimum brightness level of a display device; Ymax is the maximum brightness level of the display device; Yjnd is the minimum reproducible brightness; γ is a gamma value of the display device; and α is a parameter showing the human eye's visual characteristic against brightness.

In step S402, the brightness of respective pixels of the predictive image signal in each candidate mode of the object macro block is converted by use of a parameter showing the characteristic of the display device and another parameter showing the visual characteristic against brightness and with use of, e.g., mathematical Expression 2.

In step S403, in connection with each of the candidate modes, a square sum D of an error in the converted input image signal and an error in the predictive image signal in each candidate mode are calculated.

In step S404, prediction mode information and a predictive image signal—pertaining to a candidate mode, among all the candidate modes, where cost J represented by, e.g., mathematical Expression 9 becomes minimum—are output. Encoding is performed by use of the output prediction mode information and the pre-conversion predictive image signal.
J=D+λR Expression 9

In Expression 9, λ is an undefined multiplier. For instance, this multiplier is computed by calculation such as λ=0.85×2^{(QP-12)/3} by use of the quantization step QP of the macro block that is being processed. Further, reference symbol R denotes the amount of bits of a candidate mode.

In the present embodiment, an encoding error in the input image is computed from the brightness of the respective pixels perceived when the image is actually displayed on the display device, and an encoding mode can be selected such that the thus-computed value becomes minimum at a certain amount of bits. An optimum encoded image can be obtained as an image which is subjectively perceived on the display device.

The above first to fourth embodiments have described examples where a pair formed from a prediction mode and a quantization parameter is determined on a per-macro-block basis while the encoding unit is taken as a macro block. However, the encoding unit may be a plurality of macro block units or another unit such as a slice, a field, a frame, a picture, or a GOP.

Moreover, the present embodiment has been described by means of taking motion picture encoding as an example. However, the present invention can be applied to still image encoding or encoding of a multi-aspect image, as well.

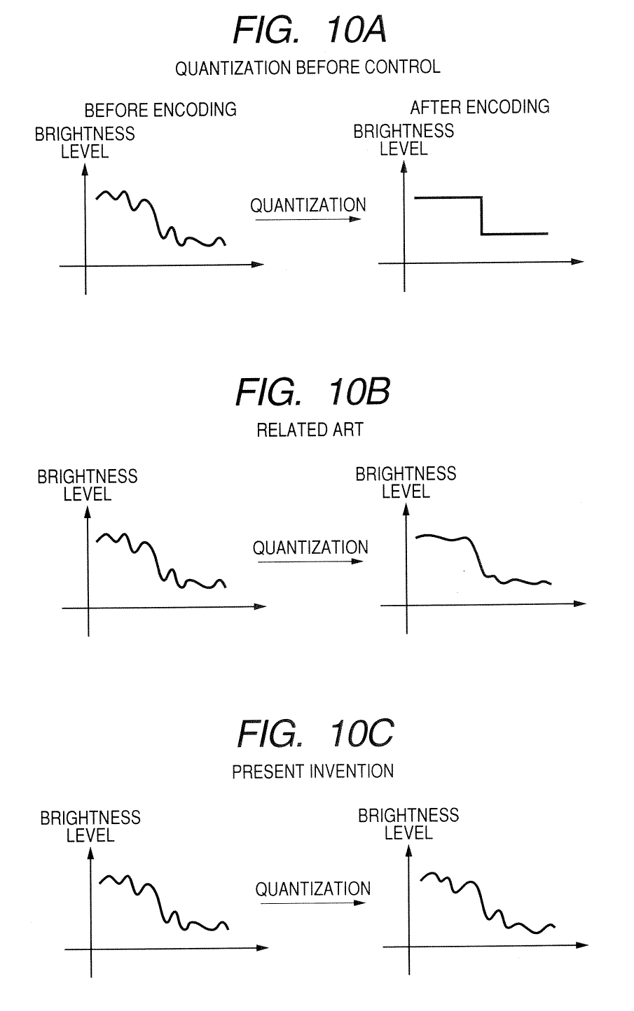

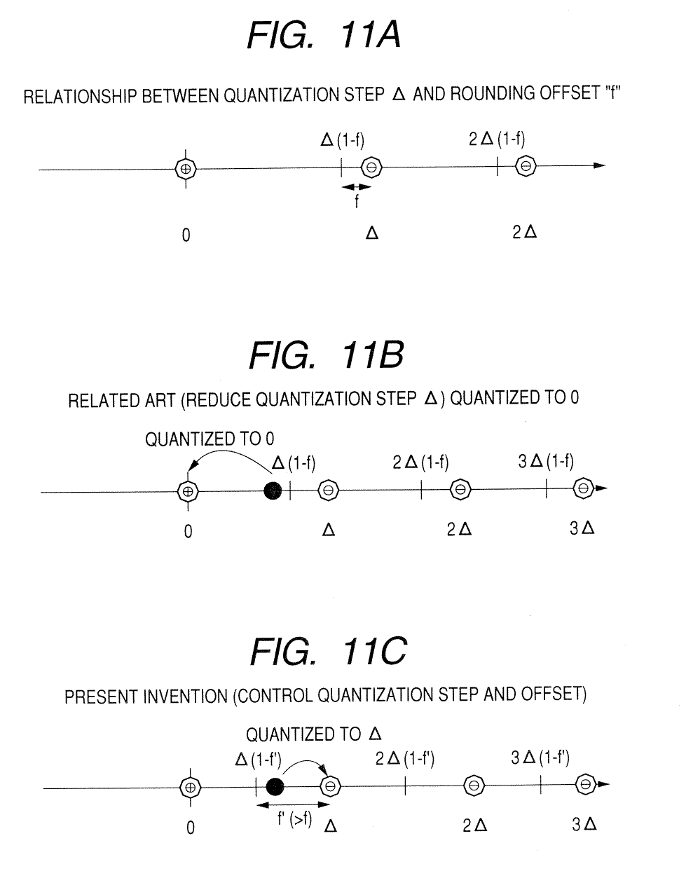

FIGS. 10A-11C show examples where the image encoder of the present invention and the related-art image encoder are compared with each other.

In general, a minute high-frequency component exists in a flat dark area where minute changes arise in a brightness level. Because of this constituent component, a difference in brightness level does not change stepwise, and hence a halftone is deemed to change smoothly.

However, this high-frequency component is deleted by means of quantization, and a difference in brightness between adjacent blocks becomes stepwise. As a result, this brightness difference appears to be greater than a brightness difference acquired in an intermediate brightness area and a brightness difference acquired in a high rightness area, because of the characteristic of the display device and the visual characteristic. For this reason, deterioration of image quality of the dark area becomes noticeable.

In a conventional method described in Japanese Patent No. 3614884, an output signal, which is formed by correcting a brightness signal in connection with a visual characteristic, is used as a signal which is formed by deleting the gamma characteristic of the monitor from the color image signal, to thus determine the quantization step. Thus, the quantization step of a block, where a brightness level—at which sensitivity to visual deterioration is low—is extremely high or low, is made small, thereby relatively reducing the quantization step in a brightness range other than the above range. The image quality of the entire image is thus improved as mentioned above.

However, the image quality of a dark area is not improved by only control of such a quantization step.

FIG. 11A is a view showing a relationship between a quantization step and a rounding offset. A symbol “Δ” denotes a quantization step; and a double circle symbol denotes a representative quantization point at each level. A value existing between two bars, where the double circle symbol is sandwiched, is quantized into a double circle symbol. Reference symbol “f” denotes a rounding offset used for controlling a round position that is employed during quantization. For instance, values falling within a range from Δ(1−f) to 2Δ(1−f) are quantized to a representative quantization point Δ.

As shown in FIG. 11B, according to the method described in Patent Document 1, when Δ is made smaller by means of controlling the quantization level, a difference between a pre-quantization value and the quantization representative point becomes smaller. However, the minute high-frequency component as designated by a solid black circle is quantized to 0 and thus cut.

As shown in FIG. 10B, stepwise changes in brightness remain as mentioned above, and deterioration of image quality is not improved. FIG. 10A shows quantization achieved before control.

Meanwhile, as shown in FIG. 11C, according to the present invention, elimination of the minute high-frequency component is prevented by means of not only controlling the quantization step of a dark area but also making the rounding offset value of the dark area larger than that acquired before correction. Thus, an encoded image such as that shown in FIG. 10C can be obtained. Accordingly, deterioration of image quality in a low brightness area (a dark area) of the encoded image, which will be noticeably caused by some display devices, can be prevented.

What is claimed is:

1. An image encoder comprising:
an image encoder that performs encoding of an image; and
a setting unit that sets a quantization parameter for each of encoding units arbitrary defined in the image, the quantization parameter including a rounding offset that is used in the encoding performed by the image encoder,
wherein the setting unit changes the rounding offset initially set into a larger rounding offset when brightness information of the encoding unit subjected to the encoding becomes smaller than or equal to a threshold value.

2. The image encoder according to claim 1, wherein the threshold value is a preset value.

3. The image encoder according to claim 1, wherein the quantization parameter includes a quantization step, and
wherein the image encoder further comprises an adjustment unit that adjusts the quantization step such that a magnitude of unit encoding distortion perceived on a display device becomes constant for each of the encoding units within the image, on the basis of brightness information that pertains to the encoding unit and at least one value indicating a display characteristic of the display device.

4. The image encoder according to claim 3, wherein the setting unit changes the rounding offset initially set into the larger rounding offset when the quantization step becomes smaller than or equal to an initial quantization step.

5. The image encoder according to claim 3, wherein the adjustment unit invalidates adjusting the quantization step in a case where the quantization step after the adjustment becomes smaller than or equal to an initial quantization step, and the case where a number of a coefficient that is not zero is larger than or equal to a threshold value, the coefficient being obtained by quantizing a coefficient in the encoding unit with the quantization parameter before the adjustment.

6. The image encoder according to claim 3, wherein, when a maximum brightness of the encoding unit is smaller than a minimum brightness that is displayable by the display device, the adjustment unit adjusts the quantization step with an adjustment value that is larger than zero, and the setting unit changes the rounding offset into a smaller rounding offset.

7. An image encoding method comprising:
performing encoding of an image;
setting a quantization parameter for each of encoding units arbitrary defined in the image, the quantization parameter including a rounding offset that is used in the encoding; and
changing the rounding offset initially set into a larger rounding offset when brightness information of the encoding unit subjected to the encoding becomes smaller than or equal to a threshold value.

8. The image encoding method according to claim 7, wherein the threshold value is a preset value.

9. The image encoding method according to claim 7, wherein the quantization parameter includes a quantization step, and
wherein the image encoding method further comprises adjusting the quantization step such that a magnitude of unit encoding distortion perceived on a display device becomes constant for each of the encoding units within the image, on the basis of brightness information that pertains to the encoding unit and at least one value indicating a display characteristic of the display device.

10. The image encoding method according to claim 9, further comprising changing the rounding offset initially set into the larger rounding offset when the quantization step becomes smaller than or equal to an initial quantization step.

11. The image encoding method according to claim 9, further comprising invalidating adjusting the quantization step in a case where the quantization step after the adjustment becomes smaller than or equal to an initial quantization step, and the case where a number of a coefficient that is not zero is larger than or equal to a threshold value, the coefficient being obtained by quantizing a coefficient in the encoding unit with the quantization parameter before the adjustment.

12. The image encoding method according to claim 9, further comprising performing adjusting the quantization step with an adjustment value that is larger than zero and changing the rounding offset into a smaller rounding offset, when a maximum brightness of the encoding unit is smaller than a minimum brightness that is displayable by the display device.

13. An image encoding method for performing encoding of an image by use of a prediction mode that is selected from among a plurality of prediction modes, for each of encoding units arbitrary defined in the image, the method comprising:
acquiring an amount of code corresponding to the prediction mode for each of the encoding units;
converting brightness information of an input image of the encoding unit and brightness information of a prediction image corresponding to the prediction mode, by use of a value indicating perception characteristics of a human eye with respect to light quantities and use of at least one value indicating a display characteristic of a display device;
obtaining encoding distortion by use of the converted brightness information;
selecting a pair of an amount of code involving an minimum cost and the encoding distortion from among pairs of the amount of code and the encoding distortion, based on a computing result of a cost by use of an undefined multiplier; and
determining the prediction mode to be used for the encoding, based on the selected pair of the amount of code and the encoding distortion.
